(19) United States
(12) Patent Application Publication
(10) Pub. No.: US 2020/0181548 A1
(43) Pub. Date: Jun. 11, 2020

(54) Accelerated Maturation Process (A.M.P.) device

(71) Applicant: Wendall Henrick Hall, Silver Spring, MD (US)

(72) Inventor: Wendall Henrick Hall, Silver Spring, MD (US)

(21) Appl. No.: 16/215,847

(22) Filed: Dec. 11, 2018

(51) Int. Cl. C12G 3/02; C12G 3/07; C12H 1/07

(52) U.S. Cl. CPC C12G 3/02; C12H 1/063; C12G 3/07

(57) ABSTRACT

An accelerated maturation process (A.M.P.) device that continually cycles a base liquid from a holding tank through a maturation chamber and returns the maturing base liquid to the original holding tank. The maturation chamber additionally includes the ability to hold various permeable mediums to infuse the base liquid with the flavor profile of the permeable medium during operation of the accelerated maturation process device.

Extracts, such as vanilla extract, is traditionally made in a manner similar to that used to make coffee and tea. For extracts, a Permeable Medium is placed in a Base Liquid for a varying period of time until the liquid is infused with detectable amounts of the Permeable Medium.

In the past, consumable liquids and extracts have been matured through prolong exposure to Permeable Medium, be that material wood, coffee beans, tea leaves, natural botanicals such as vanilla, or other substances. Many products have been matured in barrels constructed of wood. Over extended periods of time the maturation process produces a liquid that takes on the smell and flavor profile reflective of the Permeable Medium. The concentration of the Permeable Medium increases with the length of time the liquids is exposed to the Permeable Medium. The expense of production and storage also increases as the length of exposure to the Permeable Medium increases.

The expense of these traditional maturation processes is substantial, often constituting a large portion of the production cost, which is passed on to the consumer of the final product. One example is alcoholic beverages are often exposed to permeable wood in the form of barrel storage containers. The barrels filled with alcohol are then stored in warehouses under controlled environmental conditions for multiple years. Due to the permeable nature of the wood barrels, a significant portion of the maturing alcohol is lost due to evaporation through the pores of the wood barrels.

While steps can be taken to limit the evaporation based on temperature regulation, this is believed to interfere with the infusion of elements contained within the wood through the alcohol. When a balance is struck, the result is a large amount of evaporation, causing loss of liquid product, increasing the cost of the product, which is then passed onto the consumer.

Several processes for accelerating the maturation of alcoholic beverages have been developed over the past century which range from increasing the amount of wood surface area the alcoholic beverage is exposed to during a period of time, to adjusting the environmental conditions the alcoholic beverage is exposed to during the maturation process. Processes for infusing liquid with the characteristics of Permeable Medium have been developed as well. Such products consist of common items that include coffee, tea, and herbal extracts such as vanilla extract.

All of these processes have multiple drawbacks that result in increased production cost which is passed on to the consumer. The inventor of the disclosure presented herein has discovered the beneficial properties of an accelerated maturation process device which, when applied, results in an abbreviated creation timeframe with a lower amount of loss of product and greater penetration of Permeable Medium, thereby decreasing manufacturing cost and allowing for savings to be passed along to the consumer.

### BRIEF DESCRIPTION OF THE INVENTION

Aspects and advantages will be set forth in part in the following description, or may be obvious from the description, or may be learned through practice of the invention.

In one exemplary embodiment of the present disclosure, an accelerated maturation process (AMP) device is provided. The AMP device includes a holding tank for holding the Base Liquid to be processed, and a Maturation Chamber, positioned next to the holding tank, in which maturation is accelerated. The AMP device additionally includes trays holding Permeable Medium and a food grade Pump to effectuate the transfer of fluid between the holding tank, and the Maturation Chamber, and cycled back to the holding tank.

In another exemplary embodiment of the present disclosure, a single vessel AMP device is provided. The AMP device includes a holding tank, in this embodiment represented by a new charred American oak barrel. Contained within the holding tank is an attachment arm with an intake container attached a t the end of the arm.

At the upper portion of the attachment arm is a food grade self-priming submersible Pump responsible for cycling liquid through the intake container and returning it to the upper portion of the holding tank.

These and other features, aspects, and advantages of the present invention will become better understood with reference to the following description and appended claims. The accompanying drawings, which are incorporated in and constitute part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a perspective view of an accelerated maturation process device in accordance with an exemplary embodiment of the present disclosure.

FIG. 2 is a perspective view of a variation of an accelerated maturation process device whose single outer structure is constructed out of a new American oak barrel with a charred interior.

### DETAILED DESCRIPTION OF THE INVENTION

Reference will now be made in detail to present embodiments of the invention, one or more examples of which are illustrated in the accompanying drawings. The detailed description uses designations to refer to features in the drawings. Like or similar designations in the drawings and description have been used to refer to like or similar parts of the invention.

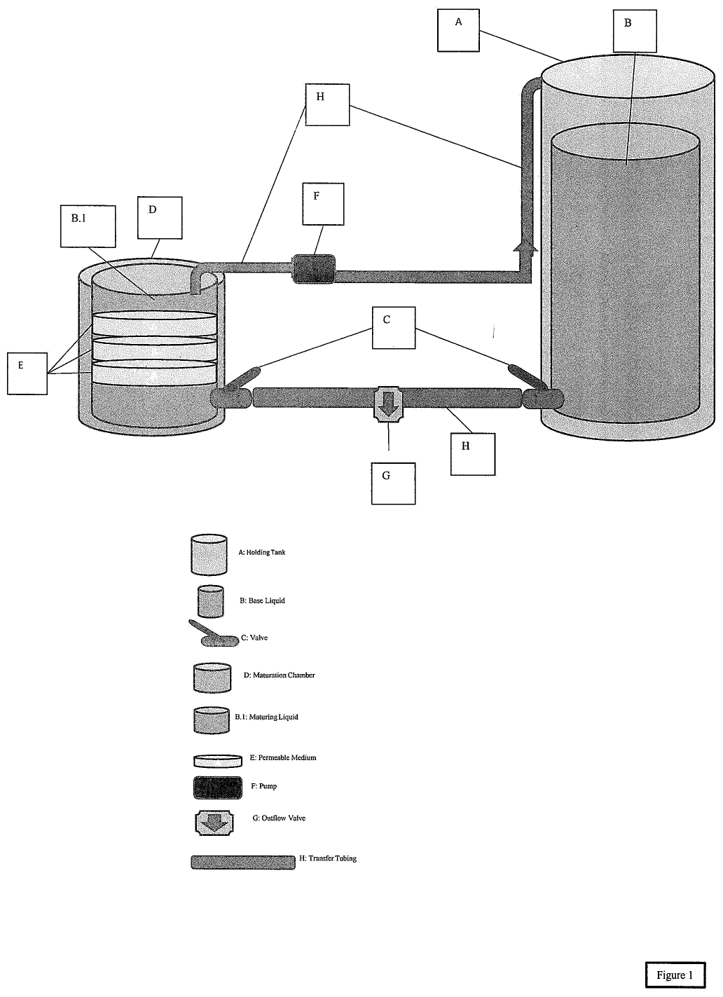

Referring now to the drawings, wherein identical letters indicated the same elements throughout the figures. FIG. 1 depicts an accelerated maturation process device for efficiently enhancing consumable liquids. Specifically, FIG. 1 provides a perspective view of a consumable liquid maturation process device in accordance with an exemplary embodiment of the present disclosure. As used herein, the term “consumable liquid” refers to any liquid beverage, such as whiskey, bourbon, scotch, rum, gin, coffee, tea, and the like.

As is depicted in FIG. 1, the accelerated maturation process device generally defines a Holding Tank A, a Maturation Chamber D, Permeable Medium E, and a Pump F. In addition, the Holding Tank A is connected to the Maturation Chamber D by transfer tubing H. The connecting Transfer Tube H has installed an outflow Valve G. Positioned inside the Maturation Chamber D is Permeable Medium E, which can be layered to the desired volume. At the top of the Maturation Chamber D is transfer tubing leading to a food grade Pump F. The food grade Pump F connects its outflow point to a Transfer Tube H, which in turn connects to the top of the Holding Tank A. Generally speaking the Holding Tank A is configured for holding a volume of Base Liquid B, and the plurality of Base Liquid B. The Base Liquid B is released from the Holding Tank A by opening the Valve C. The Base Liquid moves through the transfer tubing H, through the open Valve C, into the Maturation Chamber D. Inside the Maturation Chamber D, the Base Liquid B becomes the Maturing Liquid B.1. The Maturing Liquid B.1 envelopes and penetrates the Permeable Medium E. The Maturing Liquid B.1 is cycled out of the Maturation Chamber B.1, through the transfer tubing H, and into the food grade Pump F. The food grade Pump F pushes the Maturing Liquid B.1, through the transfer tubing H, into the Holding Tank A. Upon entry into the Holding Tank A, the Maturing Liquid B.1 becomes the Base Liquid B. Additionally, the accelerated maturation process device is configured to create a continuous cycle of Base Liquid B, through the Maturation Chamber D, around and through the Permeable Medium E, and return the Maturing Liquid B.1 to the Holding Tank A. As can be deducted, the application and exposure of the Base Liquid B, to the Permeable Medium E, in a continuous cycle, may rapidly enhance the Base Liquid B, while increasing the effectiveness of the Permeable Medium E, by increasing the penetration of the Maturing Liquid B.1 through the substance of the Permeable Medium E. This application may rapidly mature the Base Liquid B, improving a quality and taste of such Base Liquid B. Depending on the Base Liquid B and the Permeable Medium E utilized, the accelerated maturation process device may refine, filter, enhance, or otherwise mature the Base Liquid B, which upon completion is a consumable liquid.

The Base Liquid B contained within the Holding Tank A can be any suitable liquid for pairing with the Permeable Medium E. Brewed or distilled liquid can be paired with charred oak. Distilled liquid can be paired with permeable organic substances. Water can be paired with coffee or tea. An example is utilizing distilled liquid, herein referred to as Spirits B, as the Base Liquid B and paring the Spirits B with charred American oak, herein referred to as Wood E, as a Permeable Medium E. During operation of the accelerated maturation process device the plurality of the Spirits B are contained within the Holding Tank A. Upon opening of the Valve C, the spirits B flows into the Maturation Chamber D. Once in the Maturation Chamber D, the Spirits B envelop the Wood E, surrounding and penetrating the Wood E. The Spirits B.1 are removed from the Maturation Chamber D via the Transfer Tubing H by the food grade Pump F, and transferred back into the Holding Tank A. Of note, as the Spirits B come into contact and permeate the Wood E, there is an infusing of minute elements of Wood E into the maturing Spirits B.1. As the process, as encompassed in the current embodiment as displayed in FIG. 1, is cyclic in nature the Spirits B.1 experience an accelerated maturation process by establishing a forced flow of spirits B.1 in and through the Wood E. The forced cycling accelerates the traditional process that takes years as influenced by environmental conditions including temperature and gravity.

Another example is utilizing distilled liquid, herein referred to as Water B, as the Base Liquid B and paring the Water B with ground coffee, herein referred to as ground Coffee E, as a Permeable Medium E. During operation of the accelerated maturation process device the plurality of the Water B is contained within the Holding Tank A. Upon opening of the Valve C, the Water B flows into the Maturation Chamber D. Once in the Maturation Chamber D, the Water B envelops the ground coffee E, surrounding and penetrating the ground Coffee E. The Water B then becomes coffee B.1. The coffee B.1 is removed from the Maturation Chamber D via the Transfer Tubing H by the food grade Pump F, and transferred back into the Holding Tank A. Of note, as the Water B comes into contact wand permeates the ground Coffee E, there is an infusing of minute elements of ground coffee E into the maturing coffee B.1. As the process, as encompassed in the current embodiment as displayed in FIG. 1, is cyclic in nature the coffee B.1 experiences an accelerated maturation process by establishing a forced flow of coffee B.1 in and through the ground Coffee E. The forced cycling accelerates the traditional process of producing commercial volumes of coffee B.1 as normally influenced by environmental conditions consisting of temperature and gravity.

Additionally, for the embodiment depicted, the Holding Tank A and the Maturation Chamber D (FIG. 1) are generally cylindrical shape, with a lid defining a circular shape

In addition to serving the above function of maturing the Base Liquid B, the current embodiment is of food grade non-Permeable Medium. As the embodiment is a closed system made of non-Permeable Medium, the Base Liquid B and the Maturing Liquid B.1 does not decrease in overall volume. More particular, the Permeable Medium E, as it is completely enveloped, surrounded, and saturated by the Maturing Liquid B.1, is fully utilized in the maturation process. The complete utilization of the Permeable Medium E allows for a smaller amount to be used for the volume of Base Liquid B that is being processed. This results in a lowering of the overall production cost.

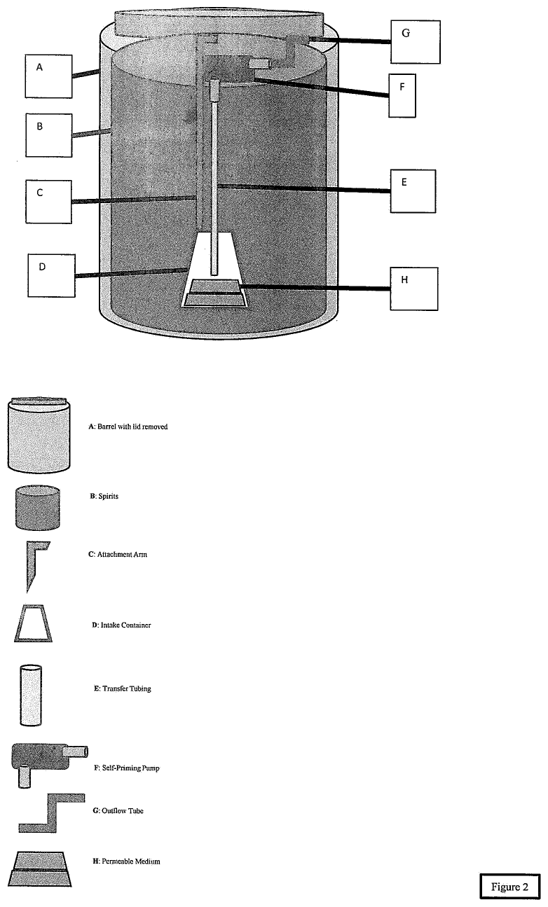

Referring now to the drawings, wherein identical letters indicated the same elements throughout the figures. FIG. 2 depicts an accelerated maturation process device for efficiently enhancing consumable liquids where in the device is primarily contained within one vessel. Specifically, FIG. 2 provides a perspective view of a one vessel consumable liquid maturation process device in accordance with an exemplary embodiment of the present disclosure. As used herein, the term “consumable liquid” refers to any liquid beverage, such as whiskey, bourbon, scotch, rum, gin, coffee, tea, and the like.

As is depicted in FIG. 2, the single vessel accelerated maturation process device generally defines a Barrel A, an Intake Container D, and a food grade self-priming Pump F. The Barrel A is primarily constructed of a new charred American oak wood barrel. In addition, the Barrel A is connected to the Intake Container D by a nonporous Attachment Arm C, which is connected to the lid of the Barrel A. The Intake Container D, containing Permeable Medium H consisting of charred or toasted American oak wood, is connected by transfer tubing E to a food grade self-priming Pump G, which in turn is connected to an outflow tube G which terminates at, and parallel to, the inner surface of the lid of the barrel A. Broadly speaking the Barrel A is configured for holding a volume of distilled liquid, herein referred to as spirits B, and the entirety of the accelerated maturation process device. Once the accelerated maturation process device is started, within the Barrel A, the Spirits B are drawn into the Intake Container D, while in the Intake Container D the spirits B will flow around and permeate through the Permeable Medium H before exiting the top of the Intake Container D through the transfer tubing E, to the food grade self-priming Pump F. The maturing spirits B are then returned to the top of the inner surface of the Barrel A through the Outflow Tube G. The accelerated maturation process device generates a constant current of the Spirits B flowing from the top to the bottom of Barrel A, into the Intake Container D near the bottom of Barrel A, around and through the Permeable Medium H, and returned to the top of Barrel A to continue the cyclic process. As can be readily appreciated, the application and exposure of the Spirits B, to the Permeable Medium H, in a continuous cycle while simultaneously generating a continuous current of the Spirits B against the charred interior surface of Barrel A, may rapidly enhance the maturation of Spirits B, while increasing the effectiveness of the Permeable Medium H, by increasing the penetration of the maturing Spirits B through the substance of the Permeable Medium H. This application as depicted in FIG. 2 may rapidly mature the Spirits B, improving a quality and taste of such Spirits B. Depending on the rate of Spirits B transit of the Intake Container D and the current of Spirits B through Barrel A as effectuated by Pump F, the accelerated maturation process device may refine, filter, enhance, or otherwise mature the Spirit B, at a rate in excess of what the industry standard method of waiting years would provide.

An accelerated maturation process device in accordance with one or more embodiments of the present disclosure may allow for relatively rapid maturation of consumable liquid. Moreover, an accelerated maturation process device in accordance with one or more embodiments of the present disclosure may be provided in various sizes. An embodiment of the present disclosure may provide a compact and contained device for processing small volumes of consumable liquids. Additionally, due to the scalable design the accelerated maturation process device may have embodiments which range from mobile in size for in home use to larger stationary units suitable for industry.

The written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. This embodiment, as illustrated in figure (FIG. 1, cycles a liquid base from one chamber and continuously cycles it through a second chamber; whereby the liquid flows around and eventually through a Permeable Medium; whereby the newly infused liquid is then cycled out of the second chamber and returned to the first chamber; wherein the cyclic flow of the liquid continues generating an infused liquid with an increasing concentration of the Permeable Medium comprising part of the liquid.

2. The embodiment of claim 1 further comprising: (a) a liquid base in one chamber; (b) wherein the liquid base is cycled into the second chamber; (c) wherein the liquid base flows around and eventually through a Permeable Medium; (d) whereby the liquid base is cycled back into the first chamber; (e) whereby the resulting infused liquid retains the characteristics of Permeable Medium.

3. The embodiment of claim 1 further comprising: (a) a liquid base of distilled alcohol in one chamber; (b) wherein the distilled alcohol is cycled through a second chamber holding a Permeable Medium consisting of American oak; (c) where within second chamber the distilled alcohol flows around and eventually through the Permeable Medium; (d) whereby the resulting infused liquid is cycled back to the first chamber; (e) whereby the resulting infused liquid retains the characteristics of the charred American oak Permeable Medium.

4. The embodiment of claim 1 further comprising: (a) a liquid base of distilled alcohol in one chamber; (b) wherein the distilled alcohol is cycled through a second chamber holding a medium consisting of wood; (c) where within the second chamber the distilled alcohol flows around and eventually permeates through the medium; (d) whereby the resulting infused liquid is returned to the first chamber; (e) whereby the resulting liquid is infused with the characteristics of the wood medium.

5. The embodiment of claim 1 further comprising; (a) liquid based consisting of distilled alcohol in one chamber; (b) wherein the liquid is cycled through a second chamber holding a Permeable Medium; (c) where within the second chamber the distilled alcohol flows around and eventually permeate through the medium; (d) whereby the resulting infused liquid is returned to the first chamber; (e) whereby the resulting liquid is infused with the characteristics of the original medium producing a concentrated extract of the Permeable Medium.

6. The embodiment of claim 1 further comprising; (a) liquid based consisting of unmatured distillate derived from the group consisting of grain spirits, sugar cane spirits, fruit spirits, or agave spirits; (b) where in the selected unmatured distillate is cycled through a second chamber holding a Permeable Medium; (c) where within the second chamber the selected distillate flows around and eventually permeate through the medium (d) whereby the resulting infused distillate is returned to the first chamber; (e) whereby the resulting distillate is infused with the characteristics of the original permeable.

7. The embodiment of claim 1 further comprising; (a) liquid based consisting of unmatured distillate derived from the group consisting of whiskey, whisky, rum, tequila, mescal, brandy, and gin; (b) where in the selected unmatured distillate is cycled through a second chamber holding a Permeable Medium; (c) where within the second chamber the selected distillate flows around and eventually permeate through the medium (d) whereby the resulting infused distillate is returned to the first chamber; (e) whereby the resulting distillate is infused with the characteristics of the original permeable.

8. The embodiment of claim 1 further comprising; (a) liquid based consisting of distillate derived from the group consisting of whiskey, whisky, rum, tequila, mescal, brandy, and gin; (b) where in the selected distillate is cycled through a second chamber holding a Permeable Medium; (c) where within the second chamber the selected distillate flows around and eventually permeate through the medium (d) whereby the resulting infused distillate is returned to the first chamber; (e) whereby the resulting distillate is infused with the characteristics of the original permeable.

9. The embodiment of claim 1 further comprising; (a) liquid based consisting of water in one chamber; (b) wherein the water is cycled through a second chamber holding a Permeable Medium consisting of ground coffee beans; (c) where within the second chamber the water flows around and eventually permeate through the ground coffee beans; (d) whereby the resulting infused water is returned to the first chamber as coffee; (e) wherein the infused water referred to as coffee is continually cycled through the second chamber; (f) whereby the resulting coffee is a concentrate infused with the characteristics of the original medium of ground coffee without the use of heat.

10. The embodiment of claim 1 further comprising; (a) liquid based consisting of water in one chamber; (b) wherein the water is cycled through a second chamber holding a Permeable Medium consisting of tea leaves; (c) where within the second chamber the water flows around and eventually permeate through the tea leaves; (d) whereby the resulting infused water is returned to the first chamber as tea; (e) wherein the infused water referred to as tea is continually cycled through the second chamber; (f) whereby the resulting tea is a concentrate infused with the characteristics of the original medium of tea leaves without the use of heat.

11. The embodiment of claim 1 further comprising; (a) liquid based in one chamber; (b) wherein the liquid is cycled through a second chamber holding a Permeable Medium; (c) where within the second chamber the liquid flows around and eventually permeate through the medium; (d) whereby the resulting infused liquid is returned to the first chamber; (e) whereby the resulting liquid is infused with the characteristics of the original medium.

12. This embodiment, as illustrated in FIG. 2, a liquid based contained within a chamber, FIG. 2 illustrates an embodiment using a barrel shaped container as the container for the liquid base, cycling the liquid base through a second chamber suspended inside the first chamber, the second chamber containing a Permeable Medium, wherein the liquid base flows around and eventually through the Permeable Medium, whereby the infused liquid is drawn out of the second chamber and is returned to the first chamber.

13. The embodiment of claim 12 further comprising: (a) the first chamber constructed as a new wood barrel constructed primarily of American oak with a charred interior; (b) wherein a liquid base of distilled alcohol, distilled from a mash consisting of a minimum of 51percent corn; (c) wherein the distilled alcohol is cycled through a second chamber, in this embodiment illustrated by a chamber constructed from new American oak which has been charred; (d) where within the second chamber the liquid flows around and eventually through a Permeable Medium, in this embodiment the Permeable Medium consist of charred American oak wood; (e) whereby the resulting infused liquid is returned to the top interior of the first chamber; (f) wherein a resulting cyclic flow is generated within the first chamber; (g) whereby the resulting cycling of liquid accelerates the permeation of the wood container in this embodiment; (h) whereby the resulting liquid is infused with the characteristics of the container of new charred American oak.

14. The embodiment of claim 12 further comprising: (a) the first chamber constructed of non-Permeable Medium; (b) wherein a liquid base is cycled through a second chamber; (c) wherein the liquid is cycled through a second chamber constructed of non-Permeable Medium; (d) where within the second chamber the liquid flows around and eventually through a Permeable Medium; (e) whereby the resulting infused liquid is returned to the top of the first chamber; (f) whereby the resulting liquid is infused with the characteristics of the Permeable Medium contained within the second chamber.

15. The embodiment of claim 12 further comprising: (a) the first chamber constructed as a wood barrel constructed primarily of American oak with a charred interior; (b) wherein an unmatured distilled spirit is selected from the group consisting of sugar spirits, grain spirits, fruit spirits, or agave spirits; (c) wherein the distilled spirits is cycled through a second chamber, in this embodiment illustrated by a chamber constructed from new American oak which has been charred; (d) where within the second chamber the distilled spirit around and eventually through a Permeable Medium, in this embodiment the Permeable Medium consist of charred American oak wood; (e) whereby the resulting infused distilled spirit is returned to the top interior of the first chamber; (f) wherein a resulting cyclic flow is generated within the first chamber; (g) whereby the resulting cycling of liquid accelerates the permeation of the wood container in this embodiment; (h) whereby the resulting spirit is infused with the characteristics of the container of new charred American oak.

16. The embodiment of claim 12 further comprising: (a) the first chamber constructed in this embodiment as a wood barrel constructed primarily of American oak with a charred interior; (b) wherein a fermented liquid is selected from the group consisting of fermented grain, fermented fruit, or fermented honey; (c) wherein the fermented liquid is cycled through a second chamber, in this embodiment illustrated by a chamber constructed from new American oak which has been charred; (d) where within the second chamber the fermented liquid flows around and eventually through a Permeable Medium, in this embodiment the Permeable Medium consist of charred American oak wood; (e) whereby the resulting infused fermented liquid is returned to the top interior of the first chamber; (f) wherein a resulting cyclic flow is generated within the first chamber; (g) whereby the resulting cycling of liquid accelerates the permeation of the wood container in this embodiment; (h) whereby the resulting fermented liquid is infused with the characteristics of the container of new charred American oak.

17. The embodiment of claim 12 further comprising: (a) the first chamber which in this embodiment is cylindrical in construction; (b) wherein a fermented liquid is selected from the group consisting of fermented grain, fermented fruit, or fermented honey; (c) wherein the fermented liquid is cycled through a second chamber constructed of a non-Permeable Medium; (d) where within the second chamber the fermented liquid flows around and eventually through a Permeable Medium contained within the second chamber; (e) whereby the resulting infused fermented liquid is returned to the top interior of the first chamber; (f) wherein a resulting cyclic flow is generated within the first chamber; (g) whereby the resulting cycling of liquid accelerates the permeation of the Permeable Medium; (h) whereby the resulting fermented liquid is infused with the characteristics of the Permeable Medium.
